(19) United States
(12) Patent Application Publication
(10) Pub. No.: US 2002/0094443 A1
(43) Pub. Date: Jul. 18, 2002

(54) High-density polyimide foam insulation

(76) Inventors: Shinichi Nakagawa, Utsunomiya (JP); Michio Shibata, Landenberg, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/998,632

(22) Filed: Dec. 3, 2001

Related U.S. Application Data
(60) Provisional application No. 60/255,538, filed on Dec. 14, 2000.

(51) Int. Cl. B32B 3/12; B32B 27/00

(52) U.S. Cl. 428/473.5; 428/158

(57) ABSTRACT

This invention relates to the use of high density polyimide foam as insulation for electrical components.

This application claims the benefit of U.S. Provisional Application No. 60/255,538, filed Dec. 14, 2000.

### BACKGROUND OF THE INVENTION

In the operation of electrical equipment, it is usually desirable to insulate certain of the components from which such equipment is made. Insulation of a component is beneficial for the purpose, for example, of reducing the energy consumption of the component, or controlling the operating range of the component.

Various materials have been used in the past to insulate electrical components, and examples of some of them are polyurethane foam, fluorocarbon polymers, and solid polyimide. Each of these materials exhibits certain limitations when used as insulation, however. Polyurethane foam, for example, does not have high temperature resistance, and is thus not well suited for use in a high temperature environment. Solid fluorocarbon polymers are characterized by low mechanical properties and a high coefficient of linear thermal expansion, and foamed fluorocarbon polymers have relatively low mechanical strength. Solid polyimide, despite its mechanical strength and temperature resistance, does not have a usefully low dielectric constant.

In JP 2000-119,437-A, a polyimide foam having a density of 0.05˜0.4 g/cm³ is prepared by adding to a polyimide matrix gas-filled microspheres produced from glass, carbon or other inorganic substances, or from resins or other organic polymers, followed by heating of the mixture. Because of the presence in the foam, however, of the material from which the microsphere is made, the foam has a dielectric constant that is too high for it to be useful as insulation for an electrical component.

A need thus still exists for a material that is appropriate for use as insulation for an electrical component and that possesses an advantageous balance of many desirable properties. It has been found that high-density non-syntactic polyimide foam, when used as insulation for an electrical component, displays high temperature resistance and high mechanical strength, and a low dielectric constant.

### BRIEF SUMMARY OF THE INVENTION

In one aspect, this invention involves an electrical component insulated by a non-syntactic polyimide foam that has a density of about 0.15 g/cm³ or more.

In another aspect, this invention involves a method of insulating an electrical component by providing a non-syntactic polyimide foam having a density of about 0.15 g/cm³ or more, and applying the polyimide foam to the electrical component as insulation.

In yet another aspect, this invention involves a method of reducing the electrical consumption of an electrical component by providing a polyimide foam having a density of about 0.15 g/cm³ or more, and applying the polyimide foam to the electrical component as insulation.

In a further aspect, this invention involves a method of controlling the range of output of an electrode by providing a non-syntactic polyimide foam having a density of about 0.15 g/cm³ or more, and applying the polyimide foam to the electrical component as insulation.

### DETAILED DESCRIPTION OF THE INVENTION

This invention relates to the use of polyimide foam as an insulating material for electrical components. To be suitable for use for such purpose, a polyimide foam will have a density of about 0.15 g/cm³ (9.7 lb/ft³) or more, and may have a density in the range of about 0.16 to about 0.32 g/cm³ (10.3 to 20.7 lb/ft³)

The polyimide from which such foam is prepared contains the characteristic —CO—NR—CO— group as a linear or heterocyclic unit along the main chain of the polymer backbone, and may be obtained, for example, from the reaction of an organic tetracarboxylic acid, or corresponding anhydride or ester derivative thereof, with an aliphatic or aromatic diamine. The organic tetracarboxylic acid in the form of its diester from methanol or ethanol can be reacted with a diamine to form a polyamide-acid/ester prepolymer which can then be foamed and cured to provide the desired polyimide foam.

The tetracarboxylic acids preferably employed in the practice of the invention, or those from which derivatives useful in the practice of this invention may be prepared, are those having the general formula:

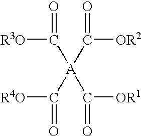

wherein A is a tetravalent organic group and R¹ to R⁴, inclusive, are each selected from the group consisting of hydrogen and lower alkyl, and preferably methyl, ethyl or propyl. The tetravalent organic group A is preferably one having one of the following structures:

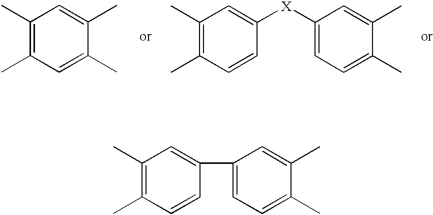

wherein X is one or more of the following:

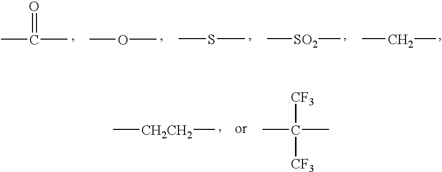

Preferred among the tetracarboxylic acids and derivatives thereof is 3,3′,4,4′-benzophenone tetracarboxylic acid and its corresponding lower alkyl (preferably lower dialkyl) esters. Also useful are aromatic dianhydrides such as pyromellitic dianhydride (PMDA), 3,3′4,4′-biphenyltetracarboxylic dianhydride (BPDA), and any other rigid aromatic dianhydride. Best results frequently occur when BPDA is used as the dianhydride component.

As an organic aromatic diamine, use is preferably made of one or more aromatic and/or heterocyclic diamines which are themselves known to the art. Such aromatic diamines can be represented by the structure: H₂N—R⁵—NH₂, wherein R⁵ is an aromatic group containing 5 to 16 carbon atoms and containing up to one hetero atom in the ring, the hetero atom being selected from the group consisting of —N—, —O— and —S—. Also included herein are those R⁵ groups wherein R⁵ is a diphenylene group or a diphenylmethane group. Representative of such diamines are:

2,6-diaminopyridine

3,5-diaminopyridine

3,3′-diaminodiphenyl sulfone

4,4′-diaminodiphenyl sulfone

4,4′-diaminodiphenyl sulfide

3,3′-diaminodiphenyl ether

4,4′-diaminodiphenyl ether

meta-phenylene diamine

para-phenylene diamine

p,p′-methylene dianiline

2,6-diamino toluene

2,4-diamino toluene.

A typical example of a polyimide prepared by a solution imidization process is a rigid, aromatic polyimide composition having the recurring unit

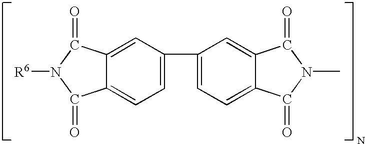

where R⁶ is greater than 60 to about 85 mole percent paraphenylene diamine (“PPD”) units and 15 to less than 40 mole % metaphenylene diamine (“MPD”) units. Polyimide compositions having 70% PPD and 30% MPD are often preferred.

In addition to other methods known in the art, a polyimide may also be prepared from the reaction of a polyisocyanate and a dianhydride.

The process by which a polyimide is prepared may vary according to the identity of the monomers from which the polymer is made up. For example, when an aliphatic diamine and a tetracarboxylic acid are polymerized, the monomers form a complex salt at ambient temperature. Heating of such a reaction mixture at a moderate temperature of about 100˜150° C. yields low molecular weight oligomers, and these oligomers may in turn be transformed into higher molecular weight polymer by further heating at an elevated temperature of about 240˜350° C. When a dianhydride is used as a monomer instead of a tetracarboxylic acid, a solvent such as dimethylacetamide or N-methylpyrrolidinone is typically added to the system. An aliphatic diamine and dianhydride also form oligomers at ambient temperature, and subsequent heating at about 150˜200° C. drives off the solvent and yields the corresponding polyimide. An aromatic diamine is typically polymerized with a dianhydride in preference to a tetracarboxylic acid, and in such a reaction a catalyst is frequently used in addition to a solvent. A nitrogen-containing base, phenol or amphoteric materials may be used as such a catalyst. Longer periods of heating may be needed to polymerize an aromatic diamine. In the formation of a polyetherimide from a bisphenol and a dinitrobisimide, the bisphenoxide salt of the bisphenol is first obtained by treatment with caustic soda, followed by an azeotropic distillation to obtain the anhydrous bisphenoxide salt. Heating the bisphenoxide salt and the dinitrobisimide at about 80˜130° C. in a solvent yields the polyetherimide.

Various methods of preparing foam from a polyimide are known in the art. For example, an organic tetracarboxylic acid in the form of an alkyl diester thereof prepared, for example, from methanol or ethanol may be reacted with one or more aromatic and/or heterocyclic diamines to form the corresponding, polyamide-acid/ester prepolymer, which can then be foamed and cured to provide the desired polyimide foam. In the preparation of the prepolymer, the tetracarboxylic acid derivative, usually in the form of the diester, is reacted with the diamine(s) at a temperature below the reflux temperature of the reaction mixture. The prepolymer may be formed as a low-molecular weight polyamide-acid/ester, which can then be heated to complete the polymerization reaction. The prepolymer can thus be in the form of a liquid or a solid having a low-molecular weight, so long as it is capable of being converted by further reaction to a high-molecular weight polyimide polymer.

Alternatively, a monomer mixture composed of an ester of benzophenone tetracarboxylic acid and an aromatic polyamine in which the mixture has a volatile content of at least 9% may be heated to a temperature at which foaming occurs contemporaneously with the polymerization of the ester and polyamine components until the polyimide foam is formed, as more particularly described in U.S. Pat. No. 3,554,939, which is incorporated as a part hereof.

In another procedure, a mixture of diamines is added to an alcoholic solution of the half ester of benzophenone tetracarboxylic acid and reacted at 158˜167° F. (70˜75° C.) to form a heavy syrup which is heated in a circulating air oven at 180° F. (82.2° C.) for about 12˜16 hours followed by drying in a vacuum oven at 176˜194° F. (80-90° C.) for 60˜90 minutes. Thereafter the polyimide precursor is pulverized into a powder which is spread over an aluminum foil on an aluminum plate and heated at 600° F. (315.6° C.) in an oven for 30 minutes to produce the foam.

In a similar procedure, the dried precursor powder formed in about the same manner may be subjected to a multi-stage technique in which the powder is placed in a pressure vessel positioned within an oven preheated at 232.2° C. (450° F.) and held at this temperature and at a reduced pressure (19.9˜9.9 inches of Hg) for 15-30 minutes. The resulting foam may then be postcured at 315.6° C. (600° F.) for 15-30 minutes in a circulating air oven.

Microwave radiation may be used for converting a polyimide precursor into a cellular structure which normally is then subjected to final curing in a thermal oven. The precursor may be used in the form of a powder formed by spray drying an alcoholic solution of the monomers, or may range in form from a liquid resin to a spreadable, pastelike formulation. The precursor may be placed in a mold and inserted in a microwave cavity operating at a powder of 10-100 KW. The precursor melts and starts to foam with contemporaneous polymerization and curing to a foam.

Yet another method of preparing a polyimide foam involves reacting an imidocaproic acid monomer with a diamine. The imidocaproic acid monomer is prepared by reacting a tetracarboxylic acid dianhydride with caprolactam in a ratio of dianhydride to caprolactam of less than about 1:1.5. The resulting polyimide powder is caused to foam by heating it to a temperature in the range of about 150° to 320° C. in a square mold. The resulting foam block is then cut into slabs or sheets of desired thickness.

Other methods of preparing polyimide foam are described in U.S. Pat. No. 3,249,561, U.S. Pat. No. 4,177,333, U.S. Pat. No. 4,241,193, U.S. Pat. No. 4,296,208, U.S. Pat. No. 4,315,076, U.S. Pat. No. 4,332,656 and U.S. Pat. No. 4,639,343, each of which is incorporated as a part hereof.

In systems generally such as those described above, a cellular structure is developed because of the evolution of condensation volatiles that are generated in situ by the high-temperature imidization reaction. For example, when using a lower alkyl ester of a tetracarboxylic acid, the resulting alcohol produced in the reaction as well as the water released during the reaction are both produced in vaporous form. These volatile gases are entrapped within the polyimide matrix and, upon stabilization, produce a foam having a homogeneous cellular structure. Foams with larger cell size may be obtained, however, by the further incorporation into the reaction mixture of a solid blowing agent such as azodicarbonamide, toluenesulfonyl hydrazide, or others as described in U.S. Pat. No. 4,476,254 or U.S. Pat. No. 4,506,038, each of which is incorporated as a part hereof.

The foam as used herein is referred to as a non-syntactic foam because any polyimide foam having the necessary properties as described herein, except a syntactic foam, may be used for the purpose of insulating an electrical component. In addition to a foam as described above in which gas is evolved during advancement of the imidization reaction, other useful non-syntactic foams therefore include those prepared by the (i) thermal decomposition of a chemical blowing agent, (ii) mechanical whipping of gases into a polymer matrix, (iii) volatilization of a low-boiling liquid within a polymer matrix, or (iv) expansion of a gas dissolved in a polymer matrix upon the reduction of pressure in the system. A foam prepared by any of the foregoing methods is a non-syntactic foam because the cells of the foam result from the dispersion in a polymer matrix of a gas in the form of the gas bubble itself, and the gas is not contained within any type of shell or other structure.

By contrast, a syntactic foam (also known as a spheroplast) is prepared by mixing with a polymer matrix hollow spherical particles (known as microspheres, microcapsules or microballoons) that contain a gas. The shell structure of the gas-filled spherical particle is typically made of glass, carbon, metal, ceramic or polymer, which material is typically different from the material from which the polymer matrix is prepared. A syntactic foam is thus considered a physical foam, and the presence of the structurally stable spheres creates a closed cell foam with good strength. A syntactic foam is not suitable for use as insulation for an electrical component, however, because the presence of a heterogeneous material in the system in the form of the spherical shell increases the dielectric constant of the foam to an unacceptable level.

To produce a polyimide foam of acceptably high density, the first step is to prepare foam in slab or block form. The second step is slicing the foam block into uniform slices or sheets of desired thickness. Any conventional slicing method may be used. If desired, the form can be originally foamed into sheets or “thin blocks” of the desired thickness. However, because these directly formed sheets tend to be irregular in thickness, have surface skins and somewhat irregular densities near their outer surfaces, slicing from larger blocks or buns is generally preferred.

Next, the foam sheet is placed in a mold having the desired final configuration. Any suitable molding apparatus may be used. Typical molds are those in which the foam sheet is placed on the platen or in a female mold half, then another platen or a male mold half is moved into position with the foam sheet somewhat compressed therebetween.

After the mold is closed and/or pressure is applied to compress the foam sheet to the desired extent, heat is applied to cure the foam and set the foam in the desired shape. The foam may be compressed to any desired extent, over the broad range of from about 0 to 99% of original thickness. The foam may be uniformly compressed, or different areas within the molded structure can be compressed to different degrees, as desired. In general, greater compression will result in a stiffer, stronger product while less compression will result in a softer, more flexible foam product of different thickness, so that the final product characteristics can be varied with different degrees of compression in those areas. Also, the spacing between the mold halves may vary, to produce products having thicker or thinner areas. Any suitable mold release agent or mold surfaces may be used to assure separation of the product from the mold.

The foam may be heated to any temperature suitable for producing the desired degree of curing for the specific foam being used. With most polyimide foam sheet materials, the best results are usually obtained when the foam is heated to a temperature of from about 220° to 320° C. for from about 0.5 to 5 minutes. The optimum temperature will vary with the specific polyimide foam used, sometimes being as low as 170° C. and other times as high as 320° C. although generally the 220°-320° C. range gives best results.

The mold may be heated in any suitable manner. Typical heating methods include conduction through one or more of the mold walls to one or more of the major foam surfaces, microwave heating, induction heating or any combination thereof. In many cases, conduction heating through one or both major foam sheet surfaces is preferred, because the surface of the foam in contact with the heated mold wall will form a tough, moisture impervious skin which is desirable for many product applications. Heating only one surface will form a skin on only that side, with the opposite foam surface remaining essentially cellular.

Once heating is complete, the mold is cooled to a suitable temperature, if necessary or desirable, and the product is removed. The product is a tough, flexible foam structure which retains the molded shape during handling.

By use of the molding process described above, a polyimide foam is molded into the shape as needed to properly serve as insulation for an electrical component. A mold is designed according to the shape of the component to be insulated, and a lower density foam is pressed into the proper shape to produce foamed insulation having the desired shape and higher density.

The type of electrical component that can be effectively insulated by a high density polyimide foam is not particularly limited, and includes components such as a radio frequency electrode, a microwave generator or any other device that uses alternating current at high power. After being insulated, components such as these are installed in various articles of manufacture such as a plasma etching chamber, chemical or physical vapor deposition chamber to make a semiconductor, or a microwave oven.

In addition to high density, the foam used in this invention for electrical insulation is characterized by a heat resistance of at least 250° C., a compressive strength of at least 0.8 MPa at 20% deformation, or 1.5 MPa at 40% deformation, and a dielectric constant at 1 MHz, as measured according to ASTM D-150, of 2.00 or less. The dielectric constant will always be greater than 1 as it is a specific value determined in comparison to the dielectric constant of a vacuum, the value of which is 1. A low dielectric constant is an important quality for insulation to possess when used to insulate an electrical component since a lower dielectric constant indicates a greater resistance to electrical conductivity.

Additives, including but not limited to a surfactant to assist in preparing the foam, may be added to the polyimide as desired provided that no deterioration in the above described properties is caused thereby.

What is claimed is:

1. An electrical component insulated by a non-syntactic polyimide foam that has a density of about 0.15 g/cm³ or more.

2. An insulated electrical component according to claim 1 wherein the polyimide foam has a density of about 0.16 to about 0.32 g/cm³.

3. An insulated electrical component according to claim 1 wherein the polyimide foam has a heat resistance of at least 250° C.

4. An insulated electrical component according to claim 1 wherein the polyimide foam has a compressive strength of at least 0.8 MPa at 20% deformation, or 1.5 MPa at 40% deformation.

5. An insulated electrical component according to claim 1 wherein the polyimide foam has a dielectric constant at 1 MHz of 2.00 or less but greater than 1.

6. An insulated electrical component according to claim 1 wherein the polyimide is prepared from an aliphatic diamine.

7. An insulated electrical component according to claim 1 wherein the polyimide is prepared from an aromatic diamine.

8. An insulated electrical component according to claim 1 wherein the polyimide is prepared from a polyisocyanate.

9. An insulated electrical component according to claim 1 wherein the polyimide is a polyetherimide.

10. An insulated electrical component according to claim 1 wherein the electrical component conducts alternating current.

11. An insulated electrical component according to claim 1 wherein the electrical component conducts alternating current at high frequency.

12. An insulated electrical component according to claim 1 wherein the electrical component is a radio frequency electrode.

13. An insulated electrical component according to claim 1 wherein the electrical component is a microwave generator.

14. An insulated electrical component according to claim 1 wherein the electrical component is a plasma etcher.

15. An article of manufacture comprising an insulated electrical component according to any one of claims 1-14.

16. A method of insulating an electrical component comprising providing a non-syntactic polyimide foam having a density of about 0.15 g/cm³ or more, and applying the polyimide foam to the electrical component as insulation.

17. A method of reducing the electrical consumption of an electrical component comprising providing a polyimide foam having a density of about 0.15 g/cm³ or more, and applying the polyimide foam to the electrical component as insulation.

18. A method of controlling the range of output of an electrode comprising providing a non-syntactic polyimide foam having a density of about 0.15 g/cm³ or more, and applying the polyimide foam to the electrical component as insulation.
